(19) United States
(12) Patent Application Publication
(10) Pub. No.: US 2008/0230327 A1
(43) Pub. Date: Sep. 25, 2008

(54) Elevator Toe Guard

(76) Inventors: Julian Cabanas Falcon, Madrid (ES); Andres Monzon-Simon, Madrid (ES); Helio Tinone, West Hartford, CT (US)

Correspondence Address: Lisa A. Bongiovi;Otis Elevator Company, 10 Farm Springs, Farmington, CT, 06032, US

(21) Appl. No.: 10/586,216

(22) PCT Filed: Mar. 9, 2004
(86) PCT No.: PCT/IB04/00676

§ 371 Date: Jul. 17, 2006

(51) Int. Cl. B66B 13/28

(52) U.S. Cl. 187/400

(57) ABSTRACT

An elevator car comprising a single, rigid toe guard member (10) slidably mounted to the bottom of the car so as to be slidable upwards in the event that the toe guard member (10) strikes the bottom of a hoist way pit.

This invention relates to an elevator toe guard assembly that may be used where an elevator pit of lesser depth than the standard is provided.

An elevator toe guard extends downwardly from the lower front sill of an elevator car. The toe guard is an important safety feature since it provides a barrier between a landing and the hoistway when the car is not aligned with the landing. For example should the car become trapped between floors, a toe guard reduces the danger of a person attempting to rescue the passengers, or the passengers themselves, falling into the hoistway. It would also prevent the possibility of a passenger's foot becoming trapped between the underneath of the elevator car and the edge of the landing if for any reason the landing doors are opened before the car is properly aligned with the floor of the landing.

Regulations and good safety practice dictate a minimum height for toe guards. Clearly in order to accommodate such a toe guard fixed to the bottom of an elevator car, the elevator pit must be sufficiently deep that the toe guard will not strike the bottom of the pit even if the elevator travels below the lowest landing and onto the buffers. On the other hand however, there is an increasing trend in modern elevator installations for a shallower pit. A shallower pit is desirable since it reduces the overall cost of installing an elevator system and represents a lesser constraint on the design of the building. Furthermore, it is often the case in older existing installations that are being updated or renewed to have a pit depth less than the standard. This represents a problem since it is undesirable and/or prohibited from a safety point of view to shorten the toe guard.

Several proposals for overcoming this problem have been described. For example, in EP-A-1118576 several mechanically complex proposals are advanced for retracting the toe guard where the pit depth is limited. However, these proposals are complex and therefore costly to produce and/or are difficult to conform to other requirements such as impact resistance.

A simpler proposal is described in WO 02/060802. In this disclosure a two-part toe guard assembly is described. One of the parts is fixed to the bottom of the elevator car whilst the other part is mounted so as to be able to slide on the fixed part. The sliding part is normally retained in its extended position under its own weight but in the event that the bottom of the toe guard should strike the floor of the pit, the sliding parts will simply be pushed upwardly relative to the fixed part thereby avoiding damage. Although this solution is an elegant and cost-effective one, it has been found in practice that it is difficult for the sliding part of the toe guard to meet some impact resistance requirements. It is an aim of the present invention therefore to provide an alternative toe guard arrangement and accordingly the present invention provides an elevator car comprising a single, rigid toe guard member slidably mounted to the bottom of the car so as to be slidable upwards in the event that the toe guard member strikes the bottom of a hoist way pit.

Thus it will be seen by those skilled in the art that in accordance with the invention whilst the toe guard still has the advantage of being retractable thereby allowing it to be used in installations with a shallower pit than the standard depth, whilst at the same time allowing the entire toe guard to comply with impact resistance requirements.

The toe guard member is preferably slidably mounted to the car door sill bracket. It may only be mounted to this bracket but preferably one or more strengthening brackets are provided that depend downwardly from the underside of the car and to which the toe guard member is slidably mounted. Such a bracket or brackets imparts a greater lateral impact resistance to the toe guard and thus facilitates meeting impact resistance requirements. The strengthening bracket(s) is preferably rigid and will therefore be shorter than the toe guard member and indeed short enough to be accommodated in the minimum vertical clearance in the pit when the elevator is at its lowest possible position—e.g. resting on its buffers.

In some embodiments a safety switch may be provided to stop the elevator in the event that the toe guard member is pushed to the upper most end of its travel. This ensures that the elevator will be stopped and the toe guard will not be damaged if it should be pushed up for any other reason than striking the base of the pit, e.g. if an object should become stuck in the shaft.

A preferred embodiment of the present invention will now be described, by way of example only, with reference to the accompanying drawings in which:

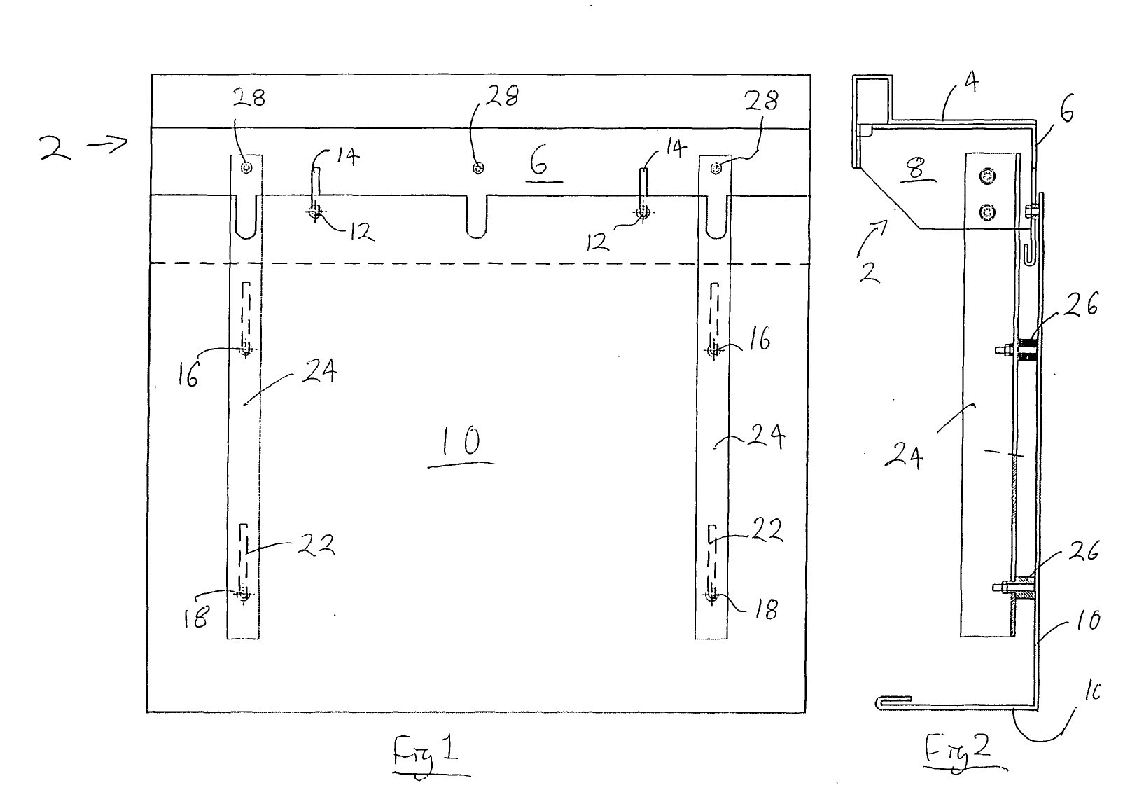

FIG. 1 is a front elevation of a single part retractable toe guard in accordance with the invention;

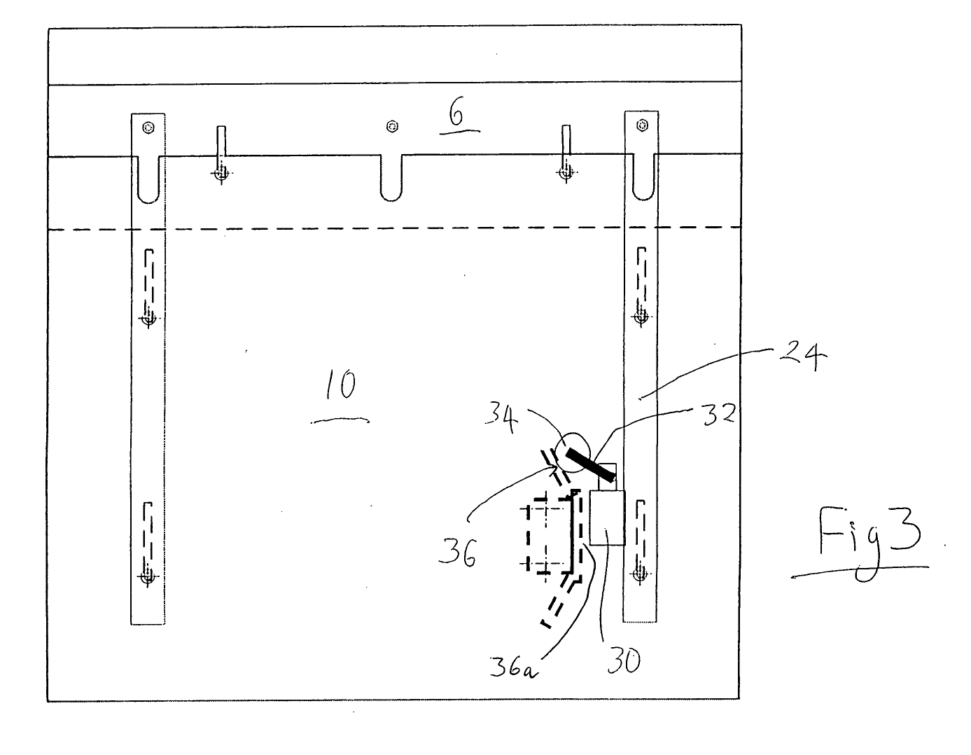

FIG. 2 is a sectional view through the toe guard assembly of FIG. 1; and

FIG. 3 is a view similar to FIG. 1 of another embodiment having a safety switch.

Referring first to FIGS. 1 and 2, there may be seen an elevator car door sill bracket 2 comprising a horizontal portion 4 and a vertical portion 6 depending from the front of the horizontal portion. The sill bracket is reinforced by a number of sill bracket gussets 8 which extend between the horizontal and vertical portions 4, 6. The toe guard member 10 is made from a single sheet of metal with the lower edge 10a thereof at 90° to give the toe guard member an L-shaped profile.

The toe guard member 10 is mounted to the door sill bracket 2 by a series of six rearwardly projecting threaded studs which are riveted to the front face of the toe guard member 10 and which move along corresponding slots. Thus a pair of studs 12 project rearwardly from close to the top edge of the toe guard plate 10 and travel within corresponding slots formed in the vertical portion 6 of the door sill bracket. Middle and lower pairs of studs 16, 18 project into corresponding pairs of vertical slots 20, 22 formed in two vertically extending brackets 24 riveted to corresponding to sill bracket gussets 8. Plastic bushings 26 are provided around each of the studs 12, 16, 18 thereby preventing direct metal to metal contact between the rear face of the toe guard member 10 and the respective brackets 6, 24.

It will be seen that three unshaped rebates are formed in the top edge of the toe guard member 10 to accommodate respective rivet heads 28 on the vertical car door sill (6). This prevents the top edge of the toe guard member 10 catching on these rivet heads 28 when it is pushed upwardly.

Operation of the toe guard assembly will now be described. In normal operation the toe guard member 10 hangs under its own weight so that each of the studs 12, 16, 18 sits at the bottom end of the respective slot 14, 20, 22. The plastic bushings substantially prevent metal to metal scraping noises being generated.

If the car should move below the lowest landing onto the buffers e.g. during maintenance or malfunction, the bottom 10a of the toe guard member may strike the pit floor. However, further downward movement of the car may be accommodated since the studs 12, 16, 18 will all be able to move up their corresponding slots 14, 20, 22 thus allowing the entire toe guard member 10 to slide upwardly. This upward movement is guided by the vertical slots 14, 20, 22 and by the plastic bushings 26. When the elevator car travels upwardly again off the buffers, the toe guard member 10 will simply fall back down again under its own weight.

Thus it will be seen that the described embodiment allows a full length toe guard member to be used even where there is insufficient pit clearance to accommodate it by allowing the toe guard member to slide upwardly relative to the bottom of the car. Furthermore, the one piece construction of the toe guard member 10 which all slides as one is both relatively inexpensive to produce but affords sufficient lateral resistance to meet elevator safety requirements.

FIG. 3 shows another embodiment of the invention. This embodiment is identical to that of the previous Figures except that it additionally comprises a safety switch mechanism. The switch mechanism comprises a switch 30 which is operated by a resiliently biased operating arm 32. The operating arm carries a wheel 34 it its distal end which acts a cam follower. The body of the switch 30 is mounted to the edge of one of the vertical brackets 24. A corresponding cam surface member 36 is mounted to the rear of the toe guard member 10.

During normal use of the elevator the cam toe guard member hangs down in the position shown in FIG. 3. In this position the cam follower wheel 34 rests against the upper part of the cam surface 36 which bends away from the switch 30. The position of the arm 32 keeps closed a set of internal contacts in the switch 30 to permit ordinary operation of the car. If the toe guard member 10 should however strike the bottom of the pit it will be pushed up relative to the car as described hereinabove. The cam surface member 36 attached to it will also move up causing the follower wheel 34 and arm 32 to move against its bias towards the axis of the switch 30 following the curved profile of the cam surface 36. Should the toe guard member 10 reach the top of its travel the follower wheel 34 will have moved to the middle of the cam surface 36a at which the point the arm 32 is almost vertical. The switch 30 is configured to open its contacts when the arm 32 is in the position which in turn is configured to arrest further downward movement of the car. This offers additional safety to prevent the car striking the bottom of the pit or a foreign object in the shaft and/or preventing damage to the toe guard member itself.

1. An elevator car comprising a single, rigid toe guard member slidably mounted to a bottom of the car so as to be slidable upwards in the event that the toe guard member strikes the bottom of a hoist way pit.

2. An elevator car as claimed in claim 1 wherein the toe guard member is slidably mounted to a car door sill bracket.

3. An elevator car as claimed in claim 1 comprising at least one strengthening bracket that depends downwardly from an underside of the car, the toe guard member being slidably mounted to said the strengthening bracket.

4. An elevator as claimed in claim 3 wherein the strengthening bracket is rigid and shorter than the toe guard member.

5. An elevator car as claimed in claim 1 further comprising a safety switch arranged to stop the elevator car in the event that the toe guard member is pushed to the uppermost end of its travel.
